(19) United States
(12) Patent Application Publication
(10) Pub. No.: US 2013/0106346 A1
(43) Pub. Date: May 2, 2013

(54) WIRELESS CHARGING SYSTEM HAVING SENSE SHUTDOWN AND METHOD THEREFOR

(71) Applicants: Stuart C. Salter, White Lake, MI (US); Richard William Kautz, North Branch, MI (US); Cornel Lewis Gardner, Romulus, MI (US); John Robert Van Wiemeersch, Novi, MI (US)

(72) Inventors: Stuart C. Salter, White Lake, MI (US); Richard William Kautz, North Branch, MI (US); Cornel Lewis Gardner, Romulus, MI (US); John Robert Van Wiemeersch, Novi, MI (US)

(73) Assignee: FORD GLOBAL TECHNOLOGIES, LLC, Dearborn, MI (US)

(21) Appl. No.: 13/282,933

(22) Filed: Oct. 27, 2011

(51) Int. Cl. H02J 7/00

(52) U.S. Cl. 320/108

(57) ABSTRACT

A vehicle wireless charging system is provided that senses an object that prohibits wireless charging when an object is sensed. The system includes a charger region and a wireless charger for generating an electromagnetic field in the charger region to charge a rechargeable device. The system also includes a proximity sensor located proximate the charger region to sense presence of an object. A controller controls the wireless charger to prohibit charging when the object is sensed.

### FIELD OF THE INVENTION

The present invention generally relates to wireless charging systems, and more particularly relates to reducing exposure to the electric signal generated by a wireless charging system to occupants within a vehicle.

### BACKGROUND OF THE INVENTION

Battery operated electronic devices, such as cell phones, employ rechargeable batteries that must be recharged when the battery charge is depleted. Typically, electric-powered or electronic devices are physically connected to an electrical charger via a wire connection. More recently, wireless charging devices such as inductive charges are available to charge the battery without any physical wire connection between the electronic device and the charging device. Wireless chargers generate an electrical signal in the form of an electromagnetic field through the use of electromagnetic transducers to transfer the electric energy from the charging device to the battery or device having a battery being charged. Inductive chargers generate an electrical signal in the form of a magnetic field through the use of inductive coils to transfer the electric energy from the charging device to the battery or device having a battery being charged. Inductive chargers have been proposed for use on vehicles in various locations having a battery within the cockpit of the vehicle, typically near the driver and other passengers for the sake of convenience to allow easy access to the devices. However, the electromagnetic field may overlap with an occupant. It is therefore desirable to provide a wireless charger within a vehicle in a manner that minimizes the introduction of electromagnetic field radiation to a user such as a driver and other passengers in the vehicle.

### SUMMARY OF THE INVENTION

According to one aspect of the present invention, a wireless charging system is provided. The charging system includes a charger region and a wireless charger for generating electric charging signals in the charger region to charge a device. The system also includes a proximity sensor located proximate the charger region to sense presence of an object. The system further includes a controller for controlling the wireless charger to at least reduce the electric charging signal when an object is sensed.

According to another aspect of the present invention, an in-vehicle wireless charging system is provided. The charging system includes a charger region provided in a vehicle and a wireless charger for generating an electromagnetic field in the charger region to charge a device. The system also includes a proximity sensor located proximate to the charger region to sense presence of an object. The system further includes a controller for controlling the wireless charger to at least reduce the electromagnetic field when an object is sensed.

According to a further aspect of the present invention, a method of controlling a wireless charging system is provided. The method includes the step of generating an electric signal with a wireless charger within a charging region to charge a device. The method also includes the step of sensing via a proximity sensor a presence of an object in close proximity to the charging region. The method further includes the step of controlling the wireless charger to at least reduce the electric signal when the object is sensed.

These and other aspects, objects, and features of the present invention will be understood and appreciated by those skilled in the art upon studying the following specification, claims, and appended drawings.

### BRIEF DESCRIPTION OF THE DRAWINGS

In the drawings:

FIG. 1 is a perspective view of a cockpit of a vehicle employing a wireless charger at various potential locations, according to several embodiments;

FIG. 2 is an enlarged view of a portion of the vehicle cockpit further illustrating a charging system employing proximity sensing and control to reduce electromagnetic field radiation exposure to occupants in the vehicle, according to one embodiment;

FIG. 3 is an enlarged view of a portion of the vehicle cockpit further illustrating a charging system employing proximity sensing surrounding the wireless charger, according to another embodiment;

FIG. 4 is a block diagram of the inductive charging system, according to one embodiment; and

FIG. 5 is a flowchart illustrating a routine for controlling the inductive charging to reduce electromagnetic field radiation exposure to an occupant, according to one embodiment.

### DETAILED DESCRIPTION OF THE PREFERRED EMBODIMENTS

As required, detailed embodiments of the present invention are disclosed herein; however, it is to be understood that the disclosed embodiments are merely exemplary of the invention that may be embodied in various and alternative forms. The figures are not necessarily to a detailed design; some schematics may be exaggerated or minimized to show function overview. Therefore, specific structural and functional details disclosed herein are not to be interpreted as limiting, but merely as a representative basis for teaching one skilled in the art to variously employ the present invention.

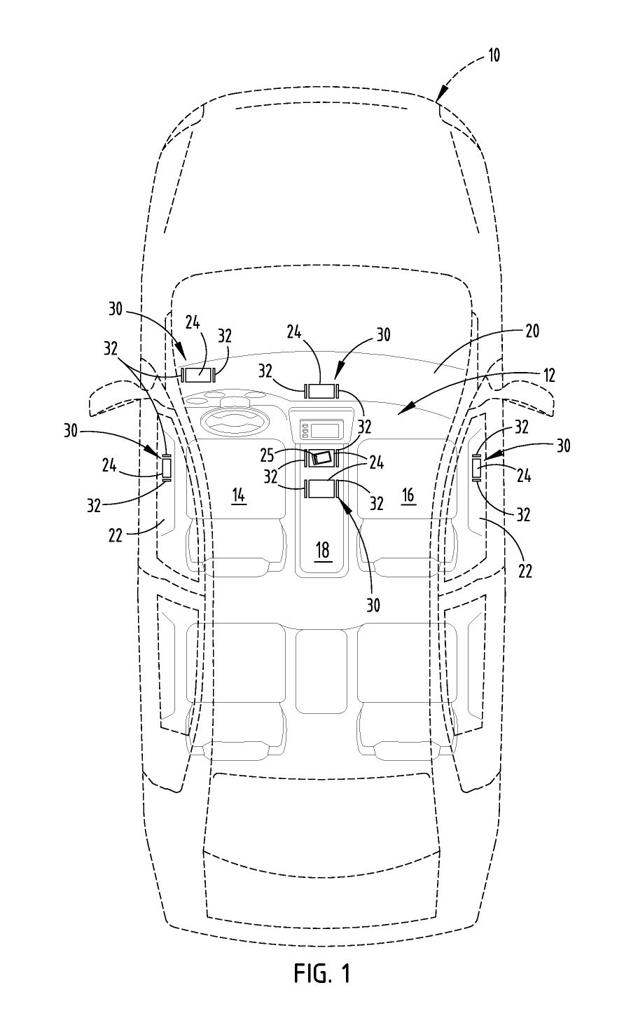

Referring to FIGS. 1-3, the interior of an automotive vehicle 10 is generally illustrated having a passenger compartment 12 employing various embodiments of a wireless charging system 30. The vehicle 10 generally includes a seating arrangement including a front driver seat 14 and front passenger seat 16, each adapted to seat a person as an occupant in passenger compartment 12 of the vehicle 10. The vehicle 10 also includes a center console 18 disposed between front seats 14 and 16, a dashboard 20 generally forward of the seats 14 and 16, and side door armrests 22 adjacent to each of seats 14 and 16. The center console 18, dashboard 20, and armrests 22, as well as other vehicle assemblies, may be equipped with various device holders such as trays and storage compartments that may receive one or more devices for wireless charging. The vehicle 10 may further include rear seating and wireless charging trays and storage compartments located in the rear seating area.

The vehicle 10 may be equipped with one or more wireless charging systems 30 for wirelessly charging one or more devices, including one or more rechargeable batteries providing electrical power within an electronic device. In one embodiment, one or more wireless charging systems 30 may be provided in storage trays or dedicated trays provided in the center console 18. The wireless charging system 30 includes a wireless charger, such as an inductive charger according to one embodiment. Inductive chargers typically include one or more inductive coils for generating electric signals in the form of an electromagnetic field (EMF) typically at low frequencies within a charging region 24. In the embodiment shown, the charging region 24 may be defined by a tray or a storage compartment for receiving a device, such that the device when located within the charging region 24 may be charged via the electromagnetic field through inductive coupling. According to another embodiment, the wireless charging system 30 may use a charging region 24 provided on one or more pads or trays provided in the vehicle dashboard 20. According to a further embodiment, the wireless charging system 30 may use a charging region 24 provided with an inductive charger 34 located in a tray within the armrest 22 extending from a vehicle door. In each of these embodiments, the wireless charging system 30 has a charging region 24 adapted to receive one or more devices, such as rechargeable batteries or electric powered or electronic devices 25 employing rechargeable batteries that may be charged via an electric signal on the charging region and may be accessible to the driver or other passengers within the cockpit 12 of vehicle 10. Examples of electronic devices 25 that may be charged by the charging system 30 include cell phones, computers, radios, lighting devices, and music and video players.

The vehicle charging system 30 includes one or more wireless chargers for generating electric charging signals in a charger region 24 to charge a device, such as a rechargeable battery or an electronic device containing a rechargeable battery. The wireless charger may include an inductive charger generating an electromagnetic field. The inductive charger may include one or more inductive coils located below or on the bottom surface of the charger region 24 such as a pad for generating an electromagnetic field in the charger region 24. The electromagnetic field passes into the charger region 24 and is intended to couple to one or more inductive coils provided in the device 25 so as to transfer electrical energy thereto for purposes of charging one or more rechargeable batteries. As a result, an electromagnetic field is present within the charger region 24. When an occupant seated within the vehicle is in close proximity to the wireless charging system, particularly the charger region 24, it may be desirable to prevent the transmission of the electromagnetic field into the user's body. The wireless charging system 30 employs one or more proximity sensors 32 located proximate to the charger region 24 to sense presence of an object, such as a body part of a person in close relation or proximity to the charger region 24 and reduces the charging signal when an object is sensed.

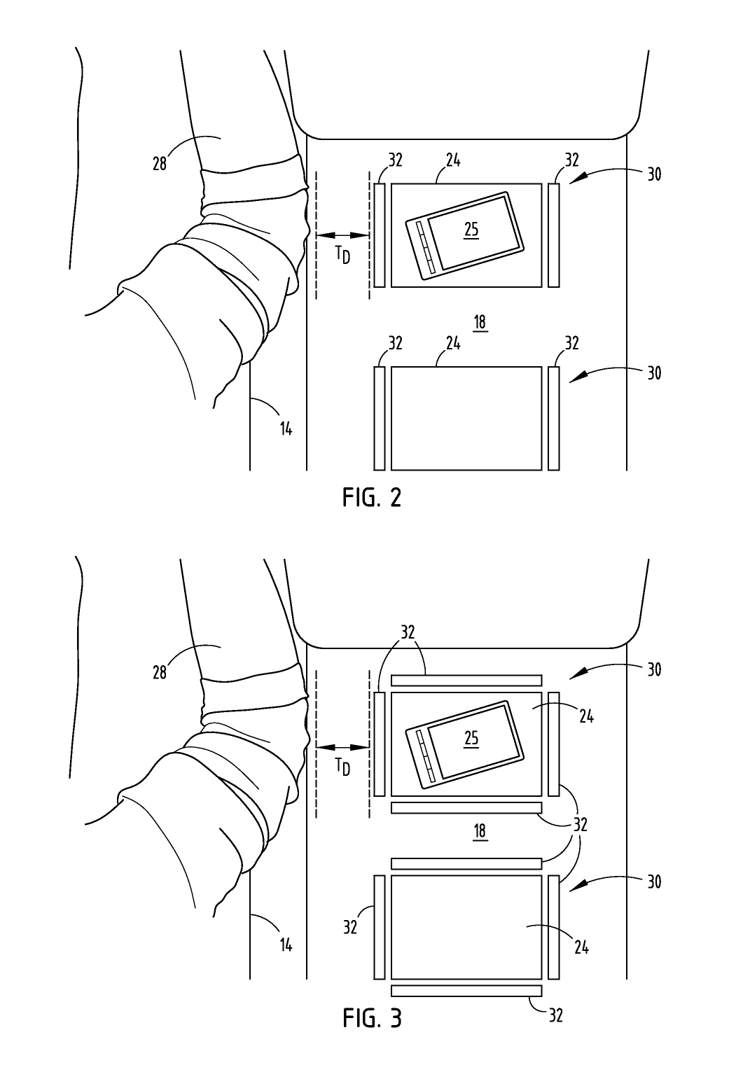

The proximity sensing may include one or more proximity sensors 32 located on at least one side of the charger region as shown in FIG. 2. First and second proximity sensors 32 are shown, with the first proximity sensor 32 located between the charger region 24 within a tray and vehicle seat 14, and the other proximity sensor 32 located between the opposite side of the charger region 24 and the opposite side seat 16. According to another embodiment, the charger region 24 may be substantially surrounded by one or more proximity sensors 32 as shown in FIG. 3. In the embodiment shown, four separate proximity sensors 24 may be arranged around the perimeter of the charger region 24. According to another embodiment, a single proximity sensor 32 may be formed to surround the charger region 24. In further embodiments, the one or more proximity sensors 32 may be located below the charger region 24 or in a lid above the charger region 24 or at other locations suitable to detect an object in close proximity to the charger region 24.

The proximity sensor 32 may be a capacitive sensor, according to one embodiment. The proximity sensor 32 provides a sense activation field to sense contact or close proximity of a user in relation to the one or more proximity sensors, such as the presence of an object 28, such as a user's arm, leg or finger. In this embodiment, the sense activation field of each proximity sensor 32 is a capacitive field and the user's body part has electrical conductivity and dielectric properties that cause a change or disturbance in the sense activation field, as should be evident to those skilled in the art. However, it should be appreciated by those skilled in the art that additional or alternative types of proximity sensors can be employed to sense an object in close proximity to the charging region 24, such as, but not limited to, inductive sensors, optical sensors, temperature sensors, resistive sensors, ultrasonic sensors, lasers, field effect sensors, the like, or a combination thereof. Exemplary proximity sensors are described in the Apr. 9, 2009 ATMEL® Touch Sensors Design Guide, 10620 D-AT42-04/09, the entire reference hereby being incorporated herein by reference.

The proximity sensors 32 may be configured to provide an adjustable range shown by distance threshold T_{D} in which to sense an object. As seen in FIG. 2, the adjustable range may be adjusted by changing the threshold distance T_{D.} According to one example, a distance threshold T_{D} may be adjusted to sense objects in a range adjustable between 2 and 12 centimeters. This may be achieved by adjusting the burst length of one or more capacitive sensors using software so as to tune the distance of the proximity sensor sense activation field relative to the charger region 24. Thus, the wireless charging system 30 may have adjustable proximity sensing to accommodate a wide variety of vehicle and charger configurations and users. Additionally, it should be appreciated that the charging may be reduced or suspended in the event that use of the device is detected, such as use of a keyboard on a phone.

The proximity sensors 32 may sense that an object is in close proximity to the charger region when the object is either detected within the charger region or within a distance of twelve centimeters (12 cm), according to one embodiment. In one embodiment, the wireless charging system controls the wireless charger to at least reduce the electric charging signal when an object is sensed by the proximity sensor. According to another embodiment, the wireless charging system prohibits or turns off the electric charging when an object is sensed in close proximity to the charging region. According to further embodiments, the wireless charging system may initially reduce the electric charging signal when an object is sensed at a first distance, such as 12 centimeters from the charger region, and may further reduce or turn off the electric charging signal when the object is detected at a second closer distance such as 2 centimeters from the charger region. The electric signal power may be thereby reduced to a level that still maintains charging of the device and suspends charging if a person places a body part very close or directly in the charging region 24.

The proximity sensor 32 may include a capacitive sensor having a fixed switching frequency or a dynamic switching frequency. With the dynamic switching frequency, frequencies which may overlap or fall in the same frequency band as the charging signal frequency may avoid interference therewith by changing the frequency. Additionally, capacitive switching circuits may be employed that mask out those frequencies used by the charger or the charger may mask out frequencies used by the proximity sensor to avoid interference.

Referring to FIG. 4, the wireless charging system 30 is further illustrated having control circuitry shown in one embodiment as a controller 40 including a microprocessor 40 and memory 44. The controller 40 may include other or additional analog and/or digital circuitry. Stored within memory 44 is a protection routine 100 and adjustable trigger distance parameters 150. The controller 40 receives as inputs the output of the proximity sensor(s) 32 and a signal indicative of the current charger state 30, e.g., on or off. Controller 40 processes the inputs with respect to the protection routine 100 and generates an output to the inductive charger 24 having inductive coil(s) 27 so as to at least reduce or prohibit the electrical charging signal to be generated by the charger 26 within the charging region when an object is sensed by the proximity sensor(s). The sensing range of the proximity sensor(s) 32 may be adjusted by selecting an adjust trigger distance parameter 150.

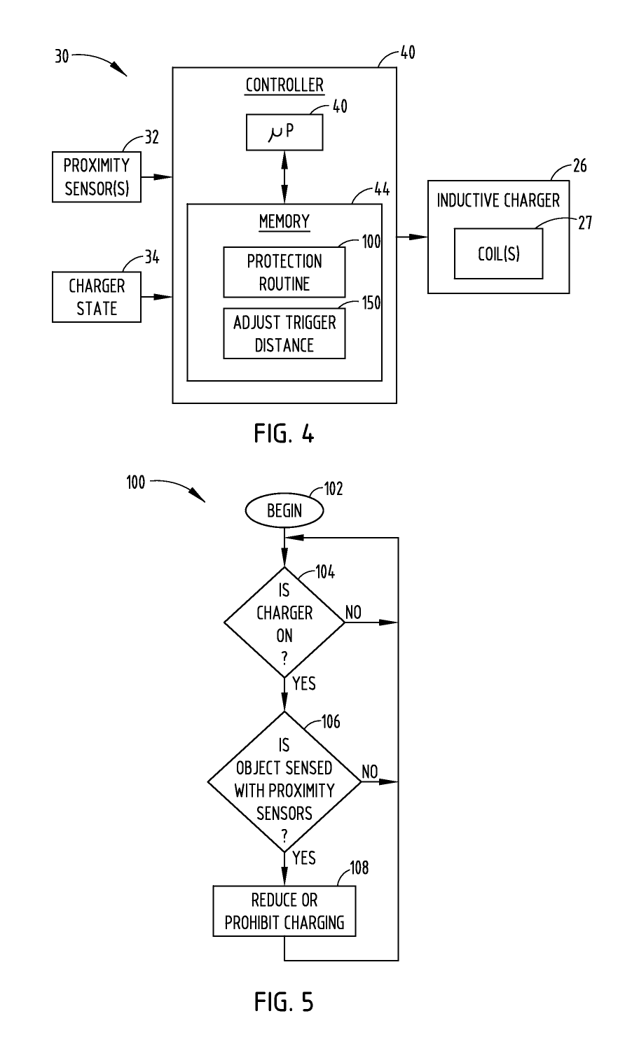

The protection routine 100 is illustrated in FIG. 5, according to one embodiment. Routine 100 begins at step 102 and proceeds to decision step 104 to determine if the wireless charger is on and, if not, returns to step 104. If the wireless charger is determined to be on, routine 100 proceeds to decision step 106 to determine if an object has been sensed in close proximity to the charger region with the proximity sensor(s). By close proximity, the sensed object may be located in the charger region or sufficiently close to the charger region such as within 12 centimeters. If no object is sensed in close proximity to the charger region, routine 100 returns to step 104. If an object is sensed in close proximity to the charger region with the proximity sensor(s), routine 100 proceeds to step 108 to reduce or prohibit charging of a device within the charger region. It should be appreciated that the wireless charging continues when the object is no longer determined to be in close proximity to the charger region. Accordingly, the presence of electromagnetic field radiation within the charger region is reduced or eliminated while an object is sensed in close proximity to the charger region.

Accordingly, the wireless charging system advantageously reduces or prohibits an electric signal in the form of an electromagnetic field within the charger region when an object, such as body part of a person, is detected in close proximity to the charger region. This advantageously prevents the electromagnetic field from penetrating into the body of a person. The wireless charging system is particularly well suited for use on a vehicle where users typically stow personal electronic devices within reach. However, the system may be useful for other applications. It should be appreciated that when the object is no longer sensed with the proximity sensor, the wireless charging may be increased and resumed.

It is to be understood that variations and modifications can be made on the aforementioned structure without departing from the concepts of the present invention, and further it is to be understood that such concepts are intended to be covered by the following claims unless these claims by their language expressly state otherwise.

We claim:

1. A wireless charging system comprising:
a charger region;
a wireless charger for generating electric charging signals in the charger region to charge a device;
a proximity sensor located proximate the charger region to sense presence of an object; and
a controller for controlling the wireless charger to at least reduce the electric charging signal when an object is sensed.

2. The charging system of claim 1, wherein the controller controls the wireless charger to prohibit charging when an object is sensed.

3. The charging system of claim 1, wherein the wireless charger comprises an inductive charger for generating an electromagnetic field.

4. The charging system of claim 1, wherein the proximity sensor comprises a capacitive sensor.

5. The charging system of claim 1, wherein the wireless charging system is employed in a vehicle.

6. The charging system of claim 5, wherein the charging region is provided in a tray within the vehicle.

7. The charging system of claim 5, wherein the proximity sensor is located between the charging region and a vehicle seat.

8. The charging system of claim 5, wherein the object sensed is one of a driver and passenger of a vehicle.

9. The charging system of claim 1, wherein the proximity has a detection field on at least one side of the charger region.

10. The charging system of claim 9, wherein the proximity sensor has a detection field surrounding the charger region.

11. An in-vehicle wireless charging system comprising:
a charger region provided in a vehicle;
a wireless charger for generating an electromagnetic field in the charger region to charge a device;
a proximity sensor located proximate to the charger region to sense presence of an object; and
a controller for controlling the wireless charger to at least reduce the electromagnetic field when an object is sensed.

12. The charging system of claim 11, wherein the wireless charger comprises an inductive charger and the controller controls the inductive charger to prohibit charging when an object is sensed via the proximity sensor.

13. A method of controlling a wireless charging system, comprising:
generating an electric signal with a wireless charger within a charging region to charge a device;
sensing via a proximity sensor a presence of an object in close proximity to the charging region; and
controlling the wireless charger to at least reduce the electric signal when the object is sensed.

14. The method of claim 13 further comprising the step of increasing the electric signal when the object is no longer sensed.

15. The method of claim 13, wherein the step of controlling comprises prohibiting charging when an object is sensed.

16. The method of claim 13, wherein the step of generating an electrical signal comprises generating an electromagnetic field via induction.

17. The method of claim 13, wherein the wireless charging system is in a vehicle.

18. The method of claim 13, wherein the proximity sensor comprises a capacitive sensor.

19. The method of claim 17, wherein the proximity sensor is located between the charging region and a vehicle seat.

20. The method of claim 13 further comprising the step of adjusting a range of the proximity sensor to sense presence of an object.
